(19) United States
(12) Patent Application Publication
(10) Pub. No.: US 2014/0193551 A1
(43) Pub. Date: Jul. 10, 2014

(54) METHOD OF PROCESSING SEEDS TO NUTRITIONALLY ENHANCE FOOD

(71) Applicant: BIO-KINETICS CORPORATION, Sheldon, IA (US)

(72) Inventor: Robert den Hoed, Sioux Center, IA (US)

(73) Assignee: Bio-Kinetics Corporation, Sheldon, IA (US)

(21) Appl. No.: 13/737,584

(22) Filed: Jan. 9, 2013

(51) Int. Cl. A23L 1/36

(52) U.S. Cl. CPC A23L 1/366
USPC 426/331

(57) ABSTRACT

A method of processing seed to nutritionally enhance food where after seeds are sanitized, washing and hydrated, the seeds are allowed a period of germination before the seeds are dried and cooled.

### BACKGROUND OF THE INVENTION

The present invention is directed to a method of processing seeds and more particularly to a method of processing seeds to enhance the nutritional qualities of food, expression of prebiotic and probiotic microflora.

Methods of processing seeds are well known in the art. Conventional methods of processing seeds leave many desired qualities unrealized. For example, it is desired to process seeds in a manner that creates a higher chelation of minerals and enhance enzyme expression and high fiber for better absorption of nutrients by the human body. Also desired is a method of processing seeds that results in lower fat and lower phytic acid. Finally, it is desired to have a method of processing seeds with a higher heat tolerance to maintain the nutritional value of the seeds, express probiotics and prebiotic expression.

Therefore, an objective of the present invention is to provide a method of processing seeds such that minerals liberated and connected to proteins for better absorption by the body and enzymes are better expressed and enhanced.

A further objective of the present invention is to provide a method of processing seeds that changes a starch to a simple sugar and expand the beneficial nature of probiotics and prebiotics found on germinated seeds.

These and other objectives will be apparent to one of ordinary skill in the art based upon the following written description, drawings, and claims.

### SUMMARY OF THE INVENTION

A method of processing seeds where after the seeds are sanitized, washed and hydrated, the seeds are subjected to a period of germination prior to drying and cooling. By permitting the seed to germinate and sprout not only is the mineral connection and enzymes liberated and enhanced to proteins improved, but by allowing the seed to sprout, starches are changed to simple sugars as well as prebiotics and probiotics expressed. The method enhances and elevates the nutritional and beneficial microflora value of the seed for use in food, but also puts seed in a better form for absorption in the body. Seed produced by this method preferably is used as an ingredient in infant food, in infant cereals, in other hot and cold cereals, in frozen dough, and for dry mixes and flours.

### BRIEF DESCRIPTION OF THE DRAWINGS

FIG. 1 is a schematic drawing of the environment of performing a method of processing seeds; and

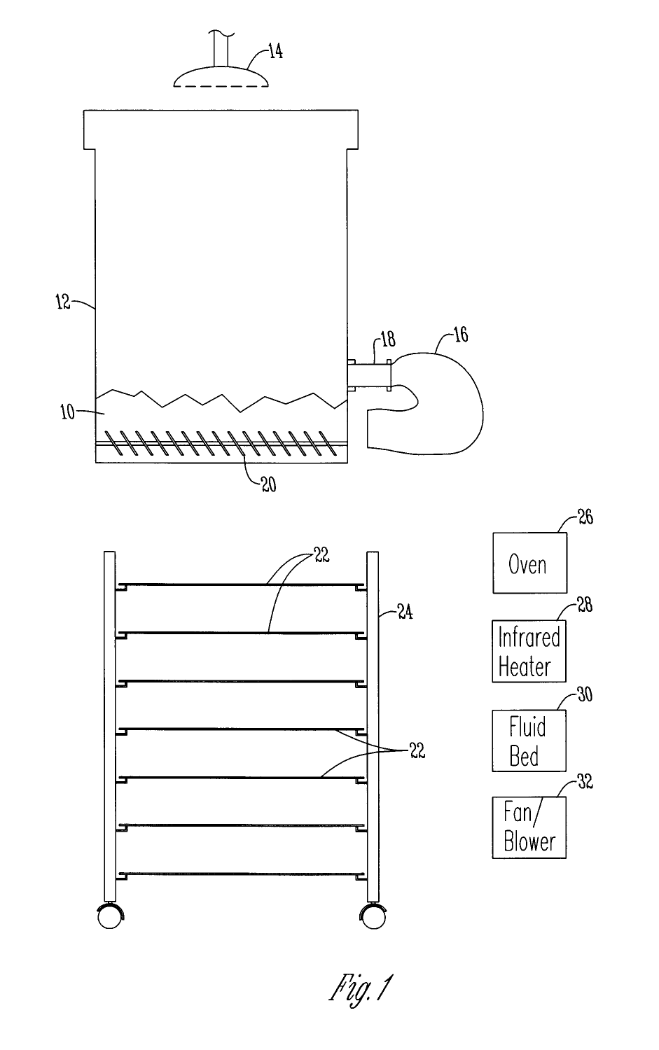

FIG. 2 is a flow diagram of a method of processing seeds.

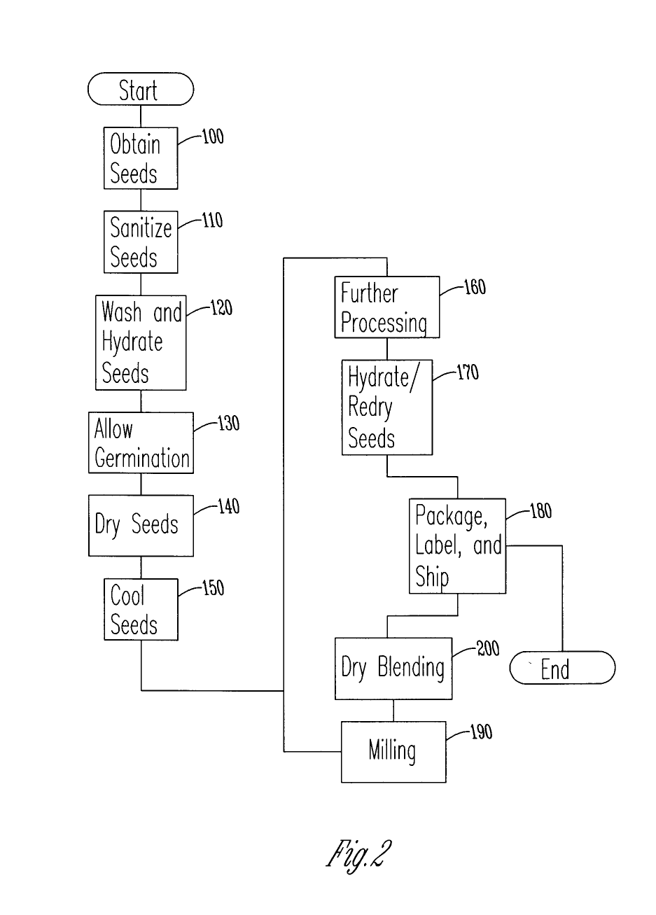

### DETAILED DESCRIPTION OF THE PREFERRED EMBODIMENTS

Referring to the Figures, a method of processing seeds to nutritionally enhance food begins at step 100 by obtaining seeds 10 from any conventional source. The seeds are of any type and include, but are not limited to, wheat, rye, barley, triticale, rice, quinoa (white, red, and black), oats and oat grouts, buckwheat and grouts, soybean, lentils (red, green, and French), garbanzo beans, flax (brown an golden), chia, corn, millet, amaranth, pea, pumpkin, spelt, kamut, or the like.

Once obtained, the seeds 10 are placed in a tank 12 where the seeds are sanitized at step 110. Preferably, the seeds 10 are sanitized by treating the seeds with any organically approved sanitation product such as calcium and hypochlorite or the like. Once sanitized, the tank 12 is drained and the seeds 10 are washed and hydrated with water at step 120, preferably by using small sprayers or misters 14.

Once the seeds are washed and hydrated, they are set aside for a germination period at step 130. The germination period preferably lasts between one minute and seven days depending upon the type of seed, amount of hydration, and/or temperature. Further, the germination period can be done without or with air circulation to provide more oxygen to the seeds. Preferably, air circulation is provided by a fan 16 that is connected to the tank 12 by tubing 18 or by a rotating auger 20 placed in the tank 12.

When the germination period is completed, the seeds 10 are removed from the tank 12 and placed on trays 22, which are positioned on racks 24, and then dried at step 140. The drying of the germinated seeds preferably is done in an oven 26 having airflow, an infrared heater 28, or a fluid bed 30 having an auger that vibrates the seeds as hot air withdraws the moisture. The drying period ends when the temperature of the seeds is between 90 and 350 degrees F.

Once dried, the seeds 10 are cooled at step 150, either in ambient air or incoming circulated air from a fan or blower 32. After the seeds 10 have cooled, they are, in one embodiment, subjected to further processing at step 160. The further processing includes grinding, blending or flaking, with or without non-sprouted seeds, flours, or superfruits. At step 170, the processed seeds are hydrated and/or redried to make the processed seed compatible for freezing, cereals, or doughs. Finally, at step 180, the processed seeds are packaged, labeled, and shipped.

Alternatively, after the seeds 10 have cooled, at step 190, the seeds are milled. Once milled, at step 200, the milled seeds are dry blended with other grains. Finally, the blended mixture is packaged and labeled at step 180.

Accordingly, a method of processing seeds to nutritionally enhance food and prebiotic and probiotic microflora has been disclosed that, at the very least, meets all the stated objectives.

1. A method of processing seeds to nutritionally enhance food and its prebiotic and probiotic microflora, comprising the steps of:
placing a plurality of seeds in a tank and sanitizing the seeds;
washing the seeds with water;
hydrating the seeds with water;
allowing the seeds to germinate over a period of time;
drying the seeds; and
cooling the seeds with ambient air.

2. The method of claim 1 further comprising the step of subjecting the seeds to further processing wherein further processing includes at least one selected from the group consisting of grinding, blending, and flaking.

3. (canceled)

4. The method of claim 2 wherein further processing includes at least one selected from the group consisting of non-sprouted seeds, flours, and superfruits.

5. The method of claim 1 further comprising the step of milling the seeds

6. The method of claim 5 further comprising the step of dry mixing the milled seeds with other grains.

7. The method of claim 1 wherein the step of sanitizing the seeds includes treating the seeds with an organically approved sanitation product.

8. The method of claim 7 wherein the organically approved sanitation product is calcium and hypochlorite.

9. The method of claim 1 wherein the period of time for germination is no more than seven days.

10. The method of claim 1 wherein the step of drying the seeds includes drying the seeds until the seeds reach a temperature between 90 and 350 degrees F.

11. The method of claim 1 wherein the step of allowing the seeds to germinate includes providing air circulation to the seeds.

12. The method of claim 1 wherein the step of drying the seeds includes using at least one drying device selected from the group consisting of an oven, an infrared heater, and a fluid bed.

13. (canceled)

14. The method of claim 1 wherein the step of washing and hydrating includes using at least one washing and hydrating device selected from the group consisting of small sprayers and misters.

15. The method of claim 1 further comprising circulating the ambient air to cool the seeds.

16. The method of claim 15 wherein the air is circulated by a fan.

17. The method of claim 1 wherein the seeds are dried by an oven having airflow.

18. The method of claim 2 further comprising the step of rehydrating the seeds.

19. The method of claim 18 further comprising the step of and redrying the seeds.

20. A method of processing seeds to nutritionally enhance food and its prebiotic and probiotic microflora, comprising the steps of:
placing a plurality of seeds in a tank and sanitizing the seeds;
washing the seeds with water;
hydrating the seeds with water;
allowing the seeds to germinate over a period of time;
drying the seeds;
cooling the seeds with ambient air; and
blending the seeds with superfruits.
